(19) United States
(12) Patent Application Publication
(10) Pub. No.: US 2011/0112663 A1
(43) Pub. Date: May 12, 2011

(54) Methods, systems, and devices for conducting a competitive sporting event

(76) Inventor: Philip Stein, Palm Beach Shores, FL (US)

(21) Appl. No.: 12/944,181

(22) Filed: Nov. 11, 2010

Related U.S. Application Data
(60) Provisional application No. 61/260,570, filed on Nov. 12, 2009.

(51) Int. Cl. G06F 19/00

(52) U.S. Cl. 700/93

(57) ABSTRACT

Methods, systems, and devices for conducting a competitive sporting event in which males and females concurrently compete as “equals” utilize a handicap system that reduces or eliminates any gender associated advantages.

### CROSS-REFERENCE TO RELATED APPLICATIONS

The present application claims priority from U.S. provisional patent application No. 61/260,570 filed on Nov. 12, 2009 which is herein incorporated in its entirety by reference.

### FIELD OF THE INVENTION

The present invention relates generally to methods, systems, and devices for conducting an entertaining competitive sporting event. More particularly, the invention relates to a competitive sporting event in which males and females concurrently compete as “equals” using a handicap system that reduces or eliminates any gender associated advantages.

### BACKGROUND

In most sports, men, by virtue of their generally greater physical strength, outperform women. On average, men can run faster, jump higher, play harder, throw, and hit further then women. Because of this gender-based disparity, most organized sports are divided into men's and women's leagues. Most sports fans, however, recognize that the physical strength and agility of a player are just one aspect of what makes watching a sporting event entertaining. Another more subjective aspect is the “heart” of the player. A player's courage, fortitude, and will are not gender-specific attributes, but characteristics that fans respect.

### SUMMARY

The invention is based on the development of methods, systems, and devices for conducting a competitive sporting event in which males and females concurrently compete as “equals” using a handicap system that reduces or eliminates any gender associated advantages. As one example, the invention can be in the form of a monthly series covering any number of different sports (e.g., tennis, golf, skiing, swimming, and bowling) based on true gender-based handicapping (“The Equalizer”), which can be broadcast throughout the world. In this example, top world-class women athletes compete with their male counterparts on an equal footing based on a handicapping system. Each athlete can have the opportunity to win money or prizes during each phase of the competition so that excitement mounts all during the match or contest, and it peaks with the final as the winner is declared.

This series can be marketed to many different sponsors as the outreach to the consumer will be very wide-spread and varied. Due to the unique handicapping system, each “Equalizer” event will often come down to the wire, so will increase audience share, create a great deal of discussion about the event itself and the series, and thus will be especially suited for television broadcast. Financial or other rewards can be presented to the athletes involved with added incentives for each participant who achieves a “personal best” or breaks records in his or her sport. Each event can have a charitable organization as a beneficiary.

In certain variations, viewers of the event can be given game cards (e.g., by sponsors) that enhance the viewers' interest in the event. For example, game cards corresponding to a particular Equalizer event can be made and distributed to the public, e.g., through chain restaurants, convenience stores, supermarkets, gas stations, stadiums. The game cards have printed thereon opportunities for the card holder to win prizes upon the occurrence of certain events in the sporting event. For instance, game cards can be targeted separately to women and men. Women's cards can provide a prize when a female competitor wins a game or accomplishes a certain act, whereas men's cards can provide a prize when a male competitor wins a game or accomplishes a certain act.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In the case of conflict, the present specification, including definitions will control.

### BRIEF DESCRIPTION OF THE DRAWINGS

FIG. 1 is an exemplary view of the front face on a game card marketed to females for use with the invention.

FIG. 2 is an exemplary view of the front face on a game card marketed to males for use with the invention.

### DETAILED DESCRIPTION

This invention encompasses various devices, systems, and methods for conducting a competitive sporting event in which males and females concurrently compete as “equals” using a handicap system that reduces or eliminates any gender associated advantages. Each athlete can have the opportunity to win money or prizes during each phase of the competition so that excitement mounts all during the match or contest, and it peaks with the final as the winner is declared. The invention can also include a promotional vehicle for enhancing revenue for television and radio broadcasters, and advertisers. The promotional vehicle can utilize game cards corresponding to a particular event that are made and distributed to the public, e.g., through chain restaurants, convenience stores, supermarkets, gas stations, stadiums.

An exemplary embodiment of the invention is a periodic (e.g., weekly, semi-weekly, monthly, etc.) series covering one or more sports wherein top world-class women athletes compete against their male counterparts on an equal footing using handicapping system based on validated statistical likelihood calculations.

There can be financial rewards to the athletes involved with added incentives for each participant who achieves a “personal best” or breaks records in his or her sport. Each event can have a strong charity as a beneficiary. The handicapping system can provide a television or other distribution network an exciting and close finish to increase audience interest Viewers can be provided an opportunity to win prizes as they can obtain game cards from sponsors that can give one or more opportunities for the card holder to win prizes upon the occurrence of certain events in the sporting event.

Sponsors of the event will have opportunities to participate in the promotion in a variety of ways. For example, each can decide whether it wants to be involved with one or several events. A sponsor might decide to be a primary sponsor of one sport (e.g. tennis) and/or the official product of all of the events. Each one of the events can have levels of sponsorship:

Title or Primary Sponsor

Presenting Sponsor

Associate Sponsor

Official Sponsor

Each one of the events might also be associated with a charity. The designated charity will make certain that the sponsors are mentioned in its media releases surrounding the events. Additional benefits for sponsors that can be offered include:

Venue and event product exclusivity for sampling or sales

Player endorsement opportunities

Television commercial buys

Client and corporate entertainment during and surrounding the events

Sponsors can be offered the following:

a) Publicity—Inclusion of Title and Presenting Sponsor on all press releases, brochures, and advertising material. Athletes involved in the events will promote the event and make personal appearances on behalf of the event and the Sponsors.

b) Exposure—Events will be attended and viewed by millions of people from all over the world. Sponsor identification, product, equipment, and services provided will be prominently displayed or advertised at each site.

c) Hospitality—Title and Presenting Sponsors will have VIP areas and hospitality tents to entertain customers and clients. Each Sponsor can receive Box Seat and preferred general admission ticket packages for distribution.

d) Revenue—Contests with attractive prizes for entering as well as major awards for winning can be offered. These promotions will be designed to commence before (e.g., three months) from each event. Publicity of the promotion and the prizes will generate additional interest in the sponsor's products or services.

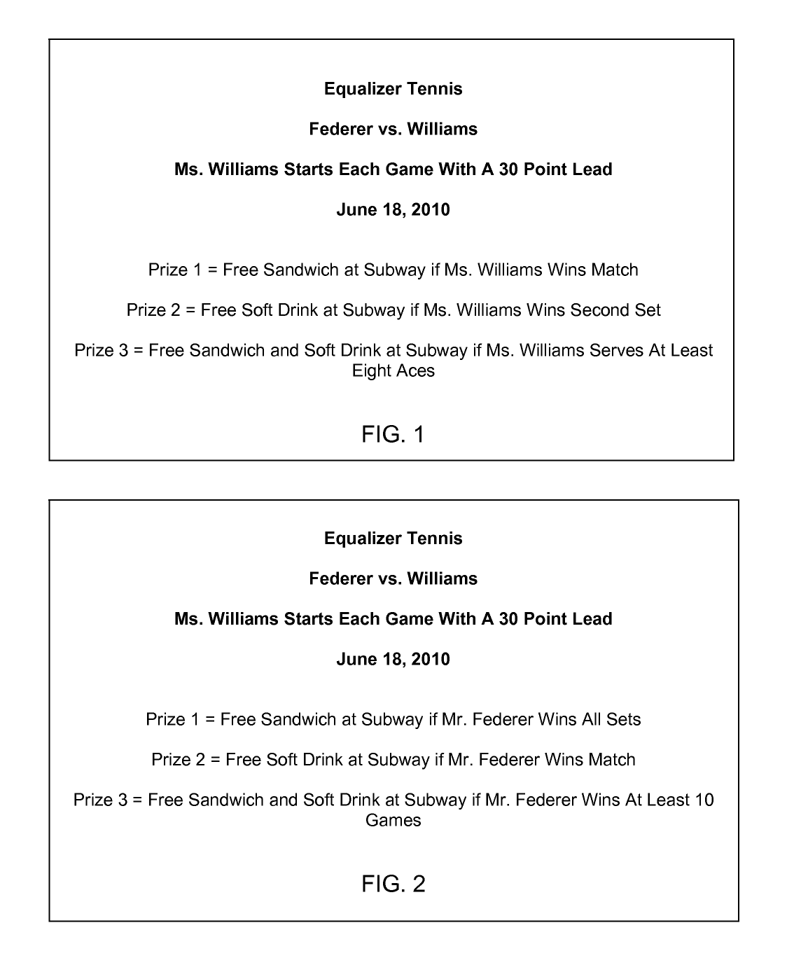

In certain embodiments, viewers of a sporting event as described above can be given game cards (e.g., by sponsors) that enhance the viewers' interest in the event. For example, game cards corresponding to a particular sporting event can be made and distributed to the public, e.g., through chain restaurants, convenience stores, supermarkets, gas stations, stadiums. Referring to FIGS. 1 and 2, the game cards can have printed thereon opportunities for the card holder to win prizes upon the occurrence of certain events in the sporting event. For instance, game cards can be targeted separately to women and men. Women's cards can provide a prize when a female competitor wins a game or accomplishes a certain act, whereas men's cards can provide a prize when a male competitor wins a game or accomplishes a certain act.

### EXAMPLES

### Example 1

### Equalizer Track & Field

In a Track & Field meet, a variety of distances and events are staged in each running event, the best time ever run by a female athlete and a male athlete is the basis of the handicapping system for each of the events. For example, if the best mile run by a male indoors was 3.45 minutes and a female was 4.10 minutes, the “The Equalizer” would be 25 seconds. Hence, in the mile event, if the male won by more than 25 seconds, he would be the winner and if he won by less than 25 seconds, he would be the loser. To make the race even more exciting, and to ensure a close finish, the female can commence running 25 seconds ahead of the male miler. If the female beats the female best time she should win the race. Likewise, if the male runner beats the male's best time for the mile, he would win the race and finish just ahead of the woman.

Big clocks are set up for the audience to watch how the times are going and who is winning Depending on the distances for each race, the handicap could be reduced to fractions of seconds for the shorter distances and increased for the longer distances. In Track & Field events where distances or heights are involved, the same formula would apply (that is, distance or height differentials are “The Equalizer”). The best male and female track stars in the world are invited to compete. Each event will have a limited number of participants, both male and female, to increase the interest and excitement.

### Example 2

### Equalizer Tennis

A top 10 world-ranked male player plays a top 10 world-ranked female player in a best three out of five set match, which is scored in the following manner:
a) Each game of the first set starts with the female up 30-Love. Each game is scored with regular scoring.
b) If she wins the first set, she will start the second set 15-Love; but if she loses the first set, she will start the second set at 40-Love.
c) If the female loses the first set at 30-Love and wins the second set at 40-Love, the third set reverts back to 30-Love. Conversely, if she wins the first set at 30-Love and loses the second set at 15-Love, the third set will go back to 30-Love. Likewise, if the male loses the first set at 30-Love and wins the second set at 15-Love, then the third set reverts back to 30-Love. If the male wins the first set at 30-Love and loses the second set at 40-Love, the third set will go back to 30-Love.
d) If the player who wins the first set at 30-Love also wins the second set at the new handicap, then the third set stays at that handicap. That is, if the female wins the third set at 30-Love and wins the second set at 15-Love, the third set will be at 15-Love.
e) This method of going up and down each set, depending upon who is victorious, will continue until one player wins three sets.
f) In the event a set goes to six games all, there will be a nine-point tie-break, decided in the following manner:
1 Should a tie-break be necessary in a set which commenced at 15-Love, the female will start at Plus 3.
2 If the set commenced at 30-Love, she will start at Plus 4
3 If it commenced at 40-Love, she will start at Plus 5
g) If the match reached the fifth and deciding set and the man has won both sets which started at 30-Love, then in the fifth set, he serves at Love-40 and the women will serve at 30-Love. If the female wins both sets at 30-Love, she serves at 15-Love and the man at Love-30. If two sets at 30-Love split, then the fifth set starts at 30-Love.

This will almost “scientifically” determine whether the top ranked male tennis player is 15, 30, 40 points per game superior to the top ranked female tennis player.

### Example 3

### Additional Equalizer Events

“The Equalizer” can easily be adjusted for many competitive sports. With creative handicapping and innovative promotions, the following sports also lend themselves to this project:

Swimming

Cycling

Bowling

Skiing

Golf

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method for conducting a sporting event that pits a male player against a female player, the method comprising the steps of:
providing the female player a handicap over the male player, wherein the handicap is determined using validated statistical likelihood calculations to eliminate any gender-based advantage that males historically have over females.
